(19) United States
(12) Patent Application Publication
(10) Pub. No.: US 2005/0097088 A1
(43) Pub. Date: May 5, 2005

(54) Techniques for analyzing the performance of websites

(76) Inventors: Dominic Bennett, Los Altos, CA (US); Matthew E. Westover, Oakland, CA (US); Dan Hu, Cupertino, CA (US)

Correspondence Address: OKAMOTO & BENEDICTO, LLP, P.O. BOX 641330, SAN JOSE, CA, 95164, US

(21) Appl. No.: 10/700,820

(22) Filed: Nov. 4, 2003

(51) Int. Cl. G06F 17/30

(52) U.S. Cl. 707/3; 707/7

(57) ABSTRACT

In one embodiment, a method of analyzing a performance of locations on a computer network includes the steps of collecting navigation histories of client computers on the computer network, processing the navigation histories to obtain relevant navigation data, and generating a report in accordance with user provided criteria, the report being based on the relevant navigation data and indicative of a performance of a location on the computer network. The computer network may include the Internet and the locations may comprise websites.

### BACKGROUND OF THE INVENTION

1. Field of the Invention

The present invention relates generally to computer networks, and more particularly, but not exclusively, to methods and apparatus for analyzing the performance of websites on the Internet. 2. Description of the Background Art

Large public computer networks, such as the Internet, allow advertisers to reach a worldwide audience twenty-four hours a day, seven days a week. This has made large public networks a cost-effective medium for marketing and selling products (e.g., goods and services). On the Internet, for example, advertising revenues allow companies to distribute free software or provide free access to websites. Needless to say, advertising helps fuel the Internet economy.

An advertising campaign on the Internet, like in other media, requires an investment in time and money. Advertisers are thus on the lookout for the best websites to place their advertisements or ways to improve their own websites. Unfortunately, conventional tools for analyzing the performance of websites are ineffective in that they are inflexible and do not provide enough information about the websites.

### SUMMARY

In one embodiment, a method of analyzing a performance of locations on a computer network includes the steps of collecting navigation histories of client computers on the computer network, processing the navigation histories to obtain relevant navigation data, and generating a report in accordance with user provided criteria, the report being based on the relevant navigation data and indicative of a performance of a location on the computer network. The computer network may include the Internet and the locations may comprise websites.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of an example computer that may be used in embodiments of the present invention.

FIG. 2 shows a schematic diagram of a computing environment in accordance with an embodiment of the present invention.

FIG. 3 shows a schematic diagram of a data packet in accordance with an embodiment of the present invention.

FIG. 4 shows a schematic diagram of a message unit in accordance with an embodiment of the present invention.

FIG. 5 shows a schematic diagram of a system for analyzing the performance of locations on a computer network in accordance with an embodiment of the present invention.

FIG. 6 shows an example screen shot of a user interface for a submission module in accordance with an embodiment of the present invention.

FIG. 7 shows an example screen shot of a user interface for a report status module in accordance with an embodiment of the present invention.

FIGS. 8-15 show example reports in accordance with embodiments of the present invention.

The use of the same reference label in different drawings indicates the same or like components.

### DETAILED DESCRIPTION

In the present disclosure, numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

The present disclosure discusses monitoring for triggering events and consumer browsing activities. Such monitoring are also disclosed in commonly-assigned U.S. application Ser. No. 10/152,204, filed on May 21, 2002 by Scott G. Eagle, David L. Goulden, Anthony G. Martin, and Eugene A. Veteska, which is incorporated herein by reference in its entirety.

Being computer-related, it can be appreciated that the components disclosed herein may be implemented in hardware, software, or a combination of hardware and software (e.g., firmware). Software components may be in the form of computer-readable program code stored in a computer-readable storage medium such as memory, mass storage device, or removable storage device. For example, a computer-readable medium may comprise computer-readable program code for performing the function of a particular component. Likewise, computer memory may be configured to include one or more components, which may then be executed by a processor. Components may be implemented separately in multiple modules or together in a single module.

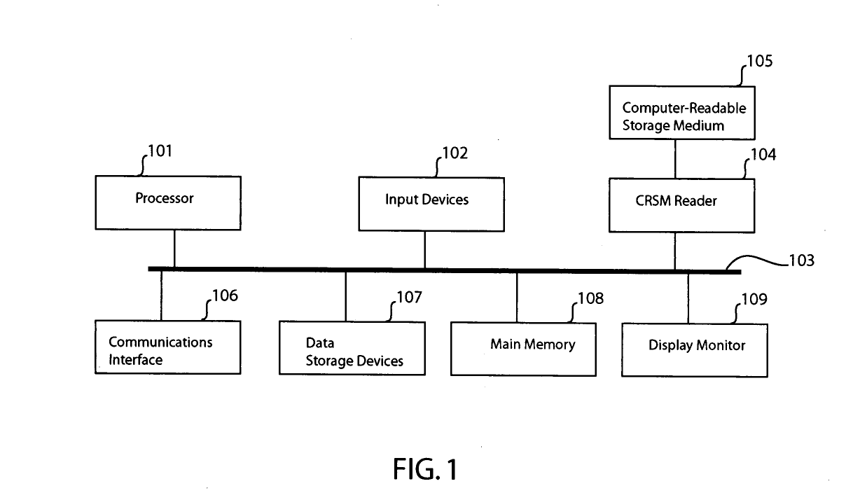

Referring now to FIG. 1, there is shown a schematic diagram of an example computer that may be used in embodiments of the present invention. Depending on its configuration, the computer shown in the example of FIG. 1 may be employed as a client computer, a server computer, a personal digital assistant, a digital phone, or other data processing device. The computer of FIG. 1 may have less or more components to meet the needs of a particular application. As shown in FIG. 1, the computer may include a processor 101, such as those from the Intel Corporation or Advanced Micro Devices, for example. The computer may have one or more buses 103 coupling its various components. The computer may include one ore more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), a communications interface 106 (e.g., network adapter, modem) for coupling to a network, one or more data storage devices 107 (e.g., hard disk drive, optical drive, FLASH memory), and a main memory 108 (e.g., RAM). Software embodiments may be stored in a computer-readable storage medium 105 for reading into a data storage device 107 or main memory 108. Software embodiments in main memory 108 may be executed by processor 101.

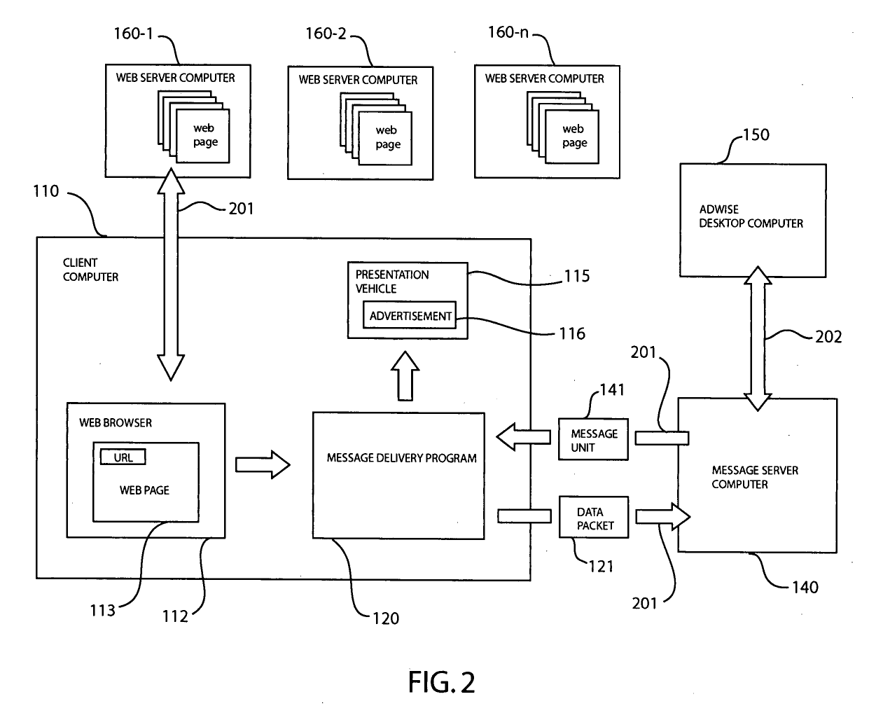

FIG. 2 shows a schematic diagram of a computing environment in accordance with an embodiment of the present invention. In the example of FIG. 2, the computing environment includes one or more web server computers 160 (i.e., 160-1, 160-2), one or more client computers 110, one or more message server computers 140, one or more desktop computers 150 and other computers not specifically shown. In the example of FIG. 2, a client computer 110 communicates with server computers (e.g., a web server computer or a message server computer) over the Internet. As such, arrows 201 denote Internet connections. Intermediate nodes such as gateways, routers, bridges, Internet service provider networks, public-switched telephone networks, proxy servers, firewalls, and other network components are not shown for clarity.

A client computer 110 is typically, but not necessarily, a personal computer such as those running the Microsoft Windows™ operating system, for example. A consumer may employ a suitably equipped client computer 110 to get on the Internet and access computers coupled thereto. For example, a client computer 110 may be used to access web pages from a web server computer 160.

A web server computer 160 may be a server computer containing information designed to attract consumers surfing on the Internet. A web server computer 160 may include advertisements, downloadable computer programs, a search engine and products available for online purchase.

A message server computer 140 may include the functionalities of a web server computer 160. Additionally, in one embodiment, a message server computer 140 may also include one or more message units 141 for delivery to a client computer 110. A message unit 141 may contain advertisements or computer-readable program code for receiving advertisements, for example. Message units are further described below. A message server computer 140 may also include downloadable computer programs and files for supporting, updating, and maintaining software components on a client computer 110.

Web server computers 160 and message server computers 140 are typically, but not necessarily, server computers such as those available from Sun Microsystems, Hewlett-Packard, or International Business Machines. A client computer 110 may communicate with a web server computer 160 or a message server computer 140 using client-server protocol. It is to be noted that client-server computing is well known in the art and will not be further described here.

As shown in FIG. 2, a client computer 110 may include a web browser 112 and a message delivery program 120. Web browser 112 may be a commercially available web browser or web client. In one embodiment, web browser 112 comprises the Microsoft Internet Explorer TM web browser. Using web browser 112, a consumer on client computer 110 may access a web page from a web server computer 160. That is, web browser 112 may be employed to receive a web page from a web server computer 160. In the example of FIG. 2, web browser 112 is depicted as displaying a web page 113 from a web server 160. A web page, such as web page 113, has a corresponding address referred to as a “URL” (Uniform Resource Locator). Web browser 112 is pointed to the URL of a web page to receive that web page in client computer 110. Web browser 112 may be pointed to a URL by entering the URL at an address window of web browser 112, or by clicking on a hyperlink pointed to that URL, for example.

In one embodiment, message delivery program 120 is downloadable from a message server computer 140 or a web server computer 160. Message delivery program 120 may be downloaded to a client computer 110 in conjunction with the downloading of another computer program. For example, message delivery program 120 may be downloaded to client computer 110 along with a utility program (not shown) that is provided free of charge or at a reduced cost. The utility program may be provided to a consumer in exchange for the right to deliver advertisements to that consumer's client computer 110 via message delivery program 120. In essence, revenue from advertisements delivered to the consumer helps defray the cost of creating and maintaining the utility program.

Message delivery program 120 is a client program in that it is stored and run in a client computer 110. Message delivery program 120 may comprise computer-readable program code for displaying advertisements in a client computer 110 and for monitoring the browsing activity of a consumer on the client computer 110. It is to be noted that the mechanics of monitoring a consumer's browsing activity, such as determining where a consumer is navigating to, the URL of web pages received in client computer 110, the domain names of websites visited by the consumer, what a consumer is typing on a web page, whether a consumer clicked on an advertisement, when a consumer activates a mouse or keyboard, and the like, is, in general, known in the art and is not further described here. For example, message delivery program 120 may learn of consumer browsing activities by receiving event notifications from web browser 112.

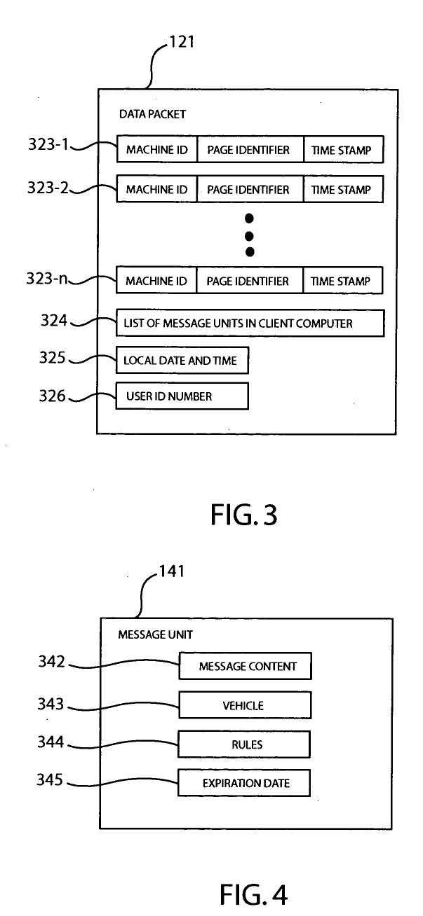

Message delivery program 120 may monitor web browser 112 for the uniform resource locator (URL) of web pages viewed by a consumer surfing on the Internet. For each domain visited by a consumer, message delivery program 120 may send a data packet 121 to message server computer 140. As shown in FIG. 3, a data packet 121 may include one or more log entries 323 (i.e., 323-1, 323-2, . . . ), a message unit list 324, a local date and time 325, and a user ID number 326. In one embodiment, a data packet 121 does not include personally identifiable information to protect the consumer's privacy.

A log entry 323 contains data indicative of a consumer navigation to particular web sites to receive particular web pages. In one embodiment, a log entry 323 includes a machine ID identifying the client computer 110 where the log entry was made, a page identifier (e.g., a URL) identifying a web page viewed by a consumer, and a time stamp indicating when the web page was received in the client computer 110. The time stamp may also include the length of time the web page remained in the client computer 110. For example, a log entry 323 may be created by message delivery program 120 when the consumer navigates to a web page by entering the URL of that web page in the address window of web browser 112. As another example, message delivery program 120 may generate a log entry 323 when the consumer clicks on a hyperlink of an advertisement 116 displayed in presentation vehicle 115, thereby pointing web browser 112 to a web page of a web server computer 160.

As is evident from the foregoing, log entries 323 document the navigation history of a client computer 110. Log entries 323 may thus be advantageously employed to deliver targeted advertisements because they are indicative of the consumer's on-line behavior. Furthermore, using a client program, such as message delivery program 120, to generate log entries 323 is advantageous because it allows for better documentation of client computer navigation history compared to server-based embodiments. More specifically, message delivery program 120 may be configured to monitor navigation to any website, not just selected websites.

A data packet 121 may also include a message unit list 324 containing a list of message units 141 stored in a message cache of a client computer 110. Message server computer 140 may examine message unit list 324 to prevent sending multiple copies of the same message unit to the client computer 110. A local date and time 325 indicate when the data packet 121 was sent from the client computer 110. A user ID number 326 anonymously identifies the consumer of the client computer 110. Additional information may also be added to a data packet 121, including data directly indicating when a particular advertisement was clicked on, keywords the consumer used to perform a search, and so on.

Message server computer 140 checks if there is a corresponding message unit 141 for each data packet 121 received from a client computer 110. If so, message server computer 140 sends a corresponding message unit 141 to the client computer 110. For example, message delivery program 120 may send a data packet 121 to message server computer 140 as the consumer navigates from “storekeeper.com” to “cars.com.” If a message unit 141 is available for the domain “cars.com,” message server computer 140 may send that message unit 141 to client computer 110. Message units 141 received from message server computer 140 may be stored in a message cache in the client computer 110 prior to processing.

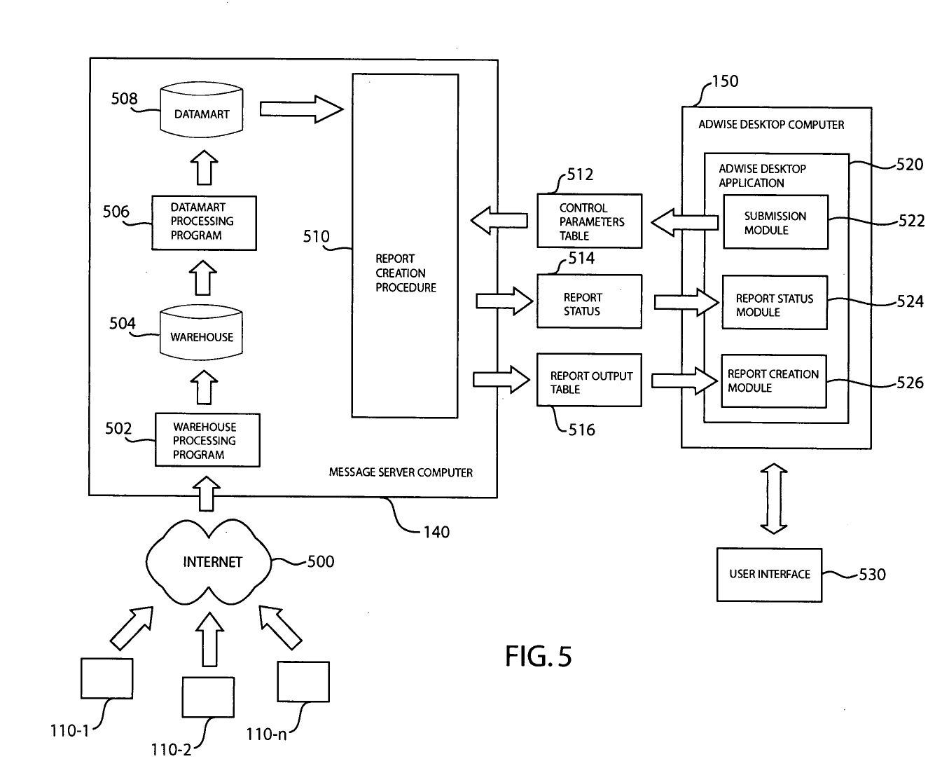

Referring to FIG. 4, a message unit 141 may include a message content 342, a vehicle 343, rules 344, and an expiration date 345. Message content 342 may include computer-readable program code, text, images, audio, video, hyperlink, and other information. A message content 342 may be an advertisement or computer-readable program code for receiving an advertisement from an ad server, for example.

Vehicle 343 indicates the presentation vehicle to be used in presenting the message content indicated by message content 342. For example, vehicle 343 may call for the use of a pop-up, banner, message box, text box, slider, separate window, window embedded in a web page, or other presentation vehicle to display a message content.

Rules 344 indicate one or more triggering conditions for processing a message unit 141. Rules 344 indicate when message delivery program 120 is to process the message unit 141. Rules 344 may specify to display a message content 342 when a consumer navigates to a specific web page or as soon as the message unit 141 is received in a client computer 110. For example, a car company may contract with the operator of a message server computer 140 to deliver a message unit 141 containing an advertisement for a minivan (hereinafter, “minivan message unit”). The rules 344 of the minivan message unit may specify that the minivan advertisement is to be displayed to consumers viewing the minivan web page of “cars.com”, In this example, the minivan web page of cars.com has the URL “www.cars.com/minivans”, When a consumer visits the main page (or any web page) of “cars.com”, message delivery program 120 (see FIG. 2) will send a data packet 121 to message server computer 140 indicating that the consumer is on “cars.com”, In response, message server computer 140 will send the minivan message unit to client computer 110. When the consumer navigates to the URL “www.cars.com/minivans”, message delivery program 120 will detect that the minivan message unit has been triggered for processing (i.e., rules 344 of the minivan message unit have been satisfied). Accordingly, message delivery program 120 will process the minivan message unit by displaying it.

Rules 344 may also include: (a) a list of domain names at which the content of a message unit 141 is to be displayed, (b) URL sub-strings that will trigger displaying of the content of the message unit 141, and (b) time and date information. As can be appreciated, rules 344 may also be extended to take into account additional information relating to a consumer (anonymously identified by a corresponding user ID number) such as the consumer's frequent flyer affiliation, club memberships, type of credit card used, hobbies and interests, and basic demographic information. Consumer related information may be stored in client computer 110 or message server computer 140. Consumer related information may be used for targeted advertising purposes, for example.

As shown in FIG. 4, a message unit 141 may also include an expiration date 345. Expiration date 345 indicates the latest date and time the message unit 141 can still be processed. In one embodiment, expired message units 141 are not processed even if their rules 344 have been satisfied. Expired message units 141 may be removed from client computer 110.

Message delivery program 120 processes a triggered message unit 141 according to its content. For example, a message delivery program 120 may process a message unit 141 by displaying its message content. In the example of FIG. 2, an advertisement 116 indicated in the message content of a message unit 141 is displayed by message delivery program 120 in a presentation vehicle 115. Message delivery program 120 may display a message content using a variety of presentation vehicles including pop-ups, pop-unders, banners, message boxes, text boxes, sliders, separate windows, windows embedded in a web page, and other mechanisms for displaying information. Message delivery program 120 may also process a message unit 141 by playing its message content if the message content is audio or video, or by running its message content if the message content is computer-readable program code. For example, message delivery program 120 may execute a message content containing computer-readable program code for receiving an advertisement from an ad server.

In one embodiment, navigation histories of client computers 110 collected in message server computer 140 by way of data packets 121 are employed in analyzing the performance of websites on the Internet. Information regarding navigation to particular web server computers 160 may be processed and stored in databases in message server computer 140 for later analysis and reporting.

In the example of FIG. 2, an AdWise™ desktop computer 150 works in conjunction with a message server computer 140 to provide an indication of the performance of websites. A desktop computer 150 may be a client computer coupled to a message server computer 140 via a connection 202. A connection 202 may be over the Internet, a local area network, a wide area network, an Intranet, or some other computer communication network. A user may employ a desktop computer 150 to submit a report request to message server computer 140. The report may include website performance data, such as website traffic, cross-traffic between websites, market penetration, and the like. The user of a desktop computer 150 may be a sales or marketing person for an advertising company, for example.

FIG. 5 shows a schematic diagram of a system for analyzing the performance of locations on a computer network in accordance with an embodiment of the present invention. The system of FIG. 5 is described using the Internet as an example. It should be noted that one of ordinary skill in the art will be able to adapt the teachings of the present disclosure to other types of networks.

As shown in FIG. 5, a message server computer 140 may comprise a warehouse processing program 502, a data warehouse 504, a datamart processing program 506, a datamart 508, and a report creation procedure 510. Warehouse processing program 502 may comprise computer-readable program code for parsing raw data from data packets 121 received from client computers 110 (i.e., 110-1, 110-2, . . .110-n) over the Internet 500 (see FIG. 2). As previously discussed, data packets 121 include the navigation histories of client computers 110, among other information. Warehouse processing program 502 also extracts other data from data packets 121 including those shown in FIG. 3. In one embodiment, warehouse processing program 502 extracts domain level and URL level data from data packets 121 and stores them in tables in data warehouse 504. Domain level and URL level data may be extracted from page identifiers indicated in data packets 121. An example of a domain level data may be navigation to “retailer.com,” whereas a URL level data may be navigation to a specific page of “retailer.com”, such as a car section having the URL “cars.retailer.com.” Note that domain level data may be obtained from URL level data.

Data warehouse 504 may comprise a commercially available database. In one embodiment, data warehouse 504 comprises an Oracle™ database commercially available from the Oracle Corporation of Redwood Shores, Calif. Because of the relatively large amount of data collected from client computers 110, data warehouse 504 may store as much as 4.2 billion rows of data, with each row having 12 columns, per month.

Datamart processing program 506 may comprise computer-readable program code for extracting relevant navigation data from data warehouse 504 and storing them in datamart 508. In one embodiment, datamart processing program 506 cleanses navigation data obtained from data warehouse 504 by removing nonsensical data. Nonsensical data include those that are inconsistent or appear to be invalid. For example, navigation data indicating that a consumer visited “retailer.com” ten different times in a particular month but only spent a total of 2 seconds keeping a web page of “retailer.com” in her client computer 110 in the same month may be deemed to be nonsensical data. Navigation data from an invalid user ID number (see FIG. 3) or machine ID may also be deemed nonsensical. Nonsensical data may be caused by a variety of things including computer error.

In one embodiment, datamart processing program 506 removes unreliable data obtained from data warehouse 504. Unreliable data include those that make sense but do not give a statistically good sample. An example unreliable data includes navigation data from short term consumers. In one embodiment, short term consumers include those that did not have any online activity before or after the month of interest. As a specific example, June navigation data from consumers that did not surf the Internet in either May or July of the same year may be deemed to be unreliable.

In light of the present disclosure, those of ordinary skill in the art will appreciate that cleansing of navigation data and removal of unreliable navigation data advantageously improve the quality of data stored in datamart 508, thereby improving the reliability of reports derived from datamart 508.

In one embodiment, datamart processing program 506 aggregates navigation data obtained from data warehouse 504. Datamart processing program 506 may aggregate different instances of navigation to a particular domain to a single event. For example, instead of separately storing a navigation to “retailer.com” on Jun. 1, 2003, Jun. 5, 2003, and Jun. 7, 2003 for a particular client computer 110 (e.g., as identified by machine ID), datamart processing program 506 may instead store a value of “3” (for the three navigations) for website traffic to “retailer.com” by the client computer 110. Aggregation of navigation data advantageously minimizes the amount of data stored in datamart 508.

Datamart 508 may comprise a database configured to store relevant navigation data. In one embodiment, datamart 508 comprises an Oracle™ database and stores relevant navigation data in tables. The relevant navigation data includes navigation histories for client computers 110. The relevant navigation data are also referred to as relevant website traffic data because navigation data may be sorted in terms of traffic to particular websites. The relevant navigation data includes domain level data for a general view of website traffic, and URL level data for a more detailed analysis of website traffic.

In one embodiment, domains and URLs stored in datamart 508 are categorized to advantageously allow for more focused website performance analysis. The categories may be based on business type or subject, for example. As a particular example, a category “travel” may include websites in the travel industry, such as the websites of airlines, car rentals, hotels, and the like; a category “search” may include popular search engines on the Internet; a category “car manufacturers” may include websites of car manufacturers; and so on. Members of the categories may be selected by human researchers and entered in a category database. When navigation data are stored in datamart 508, a category may be assigned to each domain or URL in the navigation data by looking up the category database. Note that categories may also be assigned to navigation data prior to being stored in datamart 508, such as upon storage in data warehouse 504. Categories advantageously allow for comparative website traffic analysis. For example, instead of just being able to determine traffic to a website, the website's performance may be compared against other websites in a similar category.

Compared to data warehouse 504, datamart 508 is a relatively small database. In one embodiment, datamart 508 stores relevant navigation data specifically for an Adwise™ desktop application 520. This advantageously allows datamart 508 to be optimized for website traffic analysis.

Report creation procedure 510 may comprise computer-readable program code for receiving user provided criteria from desktop application 520, querying datamart 508 based on the user provided criteria, and providing the result of the query to desktop application 520. The user provided criteria may be in the form of a control parameters table 512, while the result of the query may be provided to desktop application 520 in the form of a report output table 516.

In one embodiment, report creation procedure 510 comprises a stored procedure written in the Oracle™ PL/SQL language. In that embodiment, a UNIX daemon (not shown) in message server computer 140 polls for a newly submitted control parameters table 512. The UNIX daemon provides the newly submitted control parameters table 512 to report creation procedure 510, which employs the control parameters table to construct one or more queries. Report creation table 510 submits the queries against datamart 508 and creates a report output table 516 containing the results of the queries.

As shown in FIG. 5, an Adwise™ desktop application 520 may be running in desktop computer 150. Desktop application 520 allows a non-technical user to make use of data stored in datamart 508 to analyze the performance of websites on the Internet. Desktop application 520 may include a submission module 522, a report status module 524, and a report creation module 526.

A submission module 522 may comprise computer-readable program code for receiving report requests and submitting the report requests to report creation procedure 510. Users may submit report requests via user interface 530. A report request may include criteria provided by the user. The user provided criteria serve as control parameters for queries constructed and run by report creation procedure 510. The user provided criteria may include domains, URLs, and groupings of websites of interest. For example, a user may input the URLs of particular web pages into submission module 522 to receive a report regarding traffic, cross-traffic, or both on the web pages. A user may also specify a group of websites and request a report for that group. A group may be websites in a category of websites or any arbitrary collection of websites. That is, a user may create a group of seemingly unrelated websites according to her purpose. Thus, a user may create a “whatever group” that includes websites of car manufacturers, schools, etc. if she wants to. The user may also create a group of selected websites in a category of interest (e.g., Travel). The members of the group may be selected by the user and stored in datamart 508. This allows the user to simply input the name of the group in a report request without having to specify the websites (or web pages) included in the group.

Submission module 522 may perform error checking on user provided criteria in a report request. The error checking advantageously catches user errors that may stop the processing of the report in midstream. Examples of user errors include invalid groups, incomplete input elements, and the like. Submission module 522 may also be configured to perform raw searches on datamart 508. For example, a user may search for all domains stored in datamart 508 containing a specific string of text. This search feature allows users to conveniently look for domain names or URLs to include in a report request.

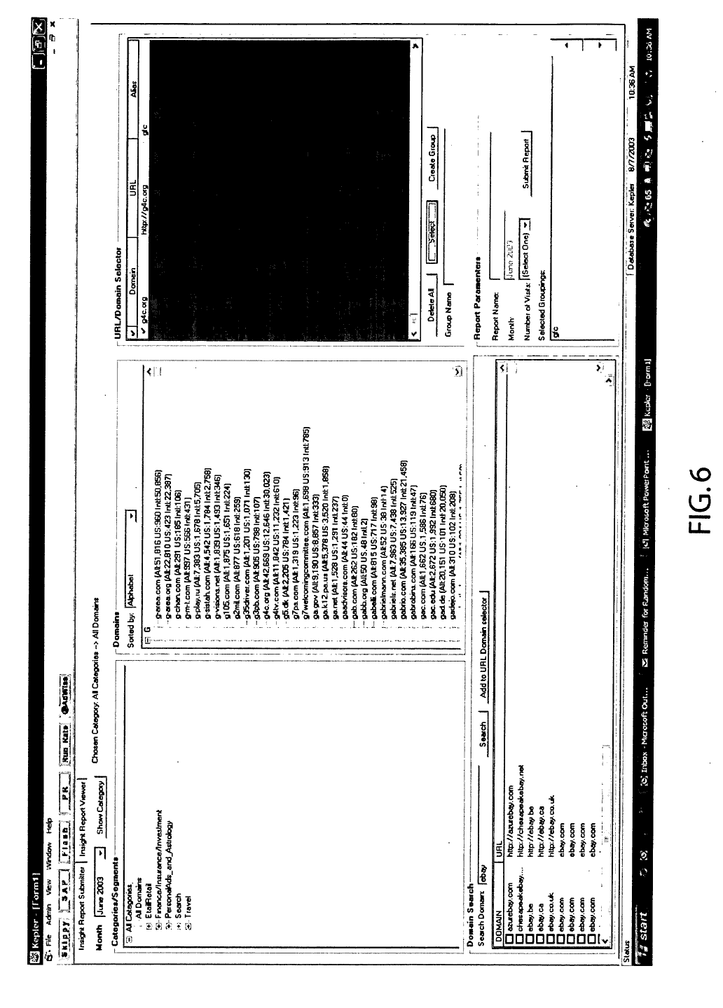

FIG. 6 shows an example screen shot of a user interface 530 for a submission module 522 in accordance with an embodiment of the present invention. In the example of FIG. 6, the user is requesting a report for navigation data obtained in “June 2003” for “all categories” of websites. Note that instead of “All Domains,” the example of FIG. 6 also allows for reports regarding websites in the categories “EtailRetail,” “Finance/Insurance/Investment,” “PersonalAds_and_Astrology,” “Search,” and “Travel.”The domains in the selected category are shown in the “Domains” window, which is depicted as listing the domains sorted by “Alphabet.” The report request in the example of FIG. 6 is for the domain “g4c.org” against “All domains” (i.e., traffic to “g4c.org” compared to traffic to “all domains”). The selected groupings in the example of FIG. 6 is “gfc”; additional groups may be specified by entering them in the window “Group Name.” The example of FIG. 6 shows the user having searched for domain names having the string “ebay.”

Referring back to FIG. 5, desktop application 520 may include a report status module 524. Report status module 524 may comprise computer-readable program code for providing the status of submitted report requests. Report status module 524 may receive requests for status by way of user interface 530. A request for status may include the name of the user who submitted the report request and the date the report request was submitted. Report status module 524 submits the request for status to report creation procedure 510. In response, report creation procedure 510 may provide report status module 524 a report status 514 indicating whether the report request has been submitted but not processed (“submitted”), is being processed (“processing”), or has been processed (“completed”). If the report request has not been processed, report status 514 may also indicate the position of the report request in the processing queue.

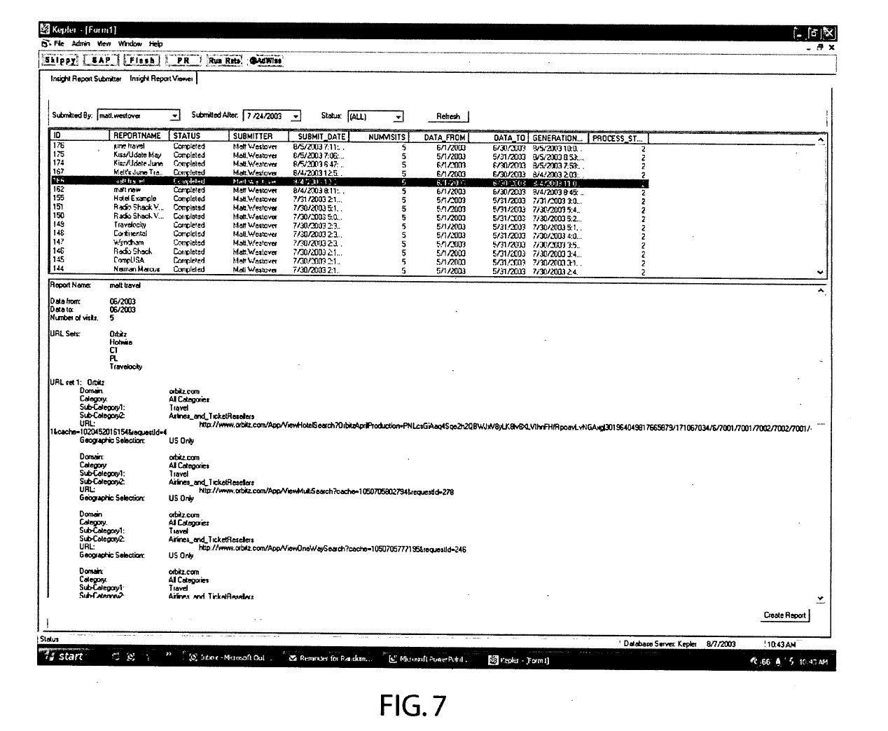

FIG. 7 shows an example screen shot of a user interface 530 for a report status module 524 in accordance with an embodiment of the present invention. In the example of FIG. 7, report status module 524 provides a status of all report requests submitted by the user “matt.westover” after “Jul. 24, 2003. The example of FIG. 7 also shows the URLs and domain names included in the control parameters table 512 of the report request.

As shown in FIG. 5, desktop application 520 may include a report creation module 526. Report creation module 526 may comprise computer-readable program code for presenting a report of website performance. In one embodiment, report creation module 526 receives a report output table 516 from report creation procedure 510. A report output table 516 may comprise the results of one or more queries submitted by report creation procedure 510 against datamart 508 based on a control parameters table 512. Report creation module 526 presents the information contained in a report output table 516 in a format that is relatively easy for a non-technical user to comprehend.

In one embodiment, report creation module 526 comprises Microsoft Visual Basic™ For Applications (VBA) code that opens a Microsoft Excel™ spreadsheet, places data from a report output table 516 into the spreadsheet, and creates objects, such as tables, charts, and graphs, using the spreadsheet. In that embodiment, report creation module 526 then opens a Microsoft Word™ word processing program template and pastes the spreadsheet objects into the template to create the final report that is presented to the user.

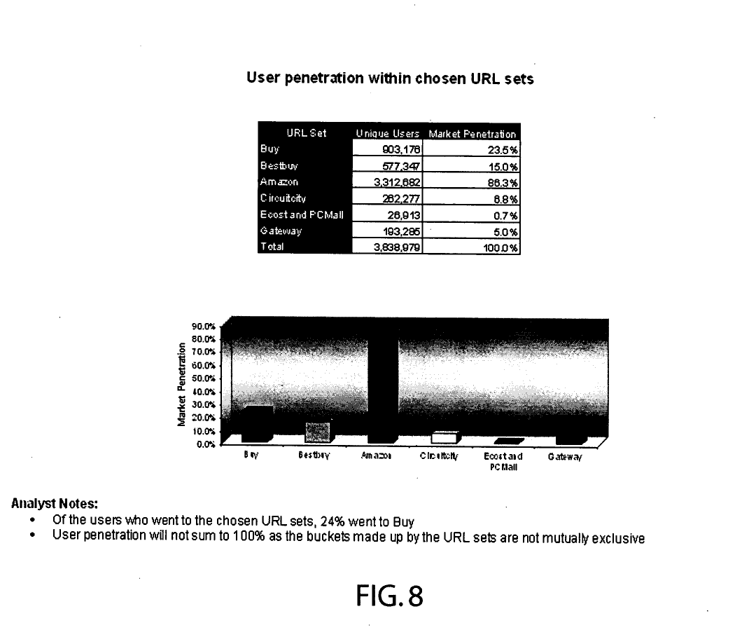

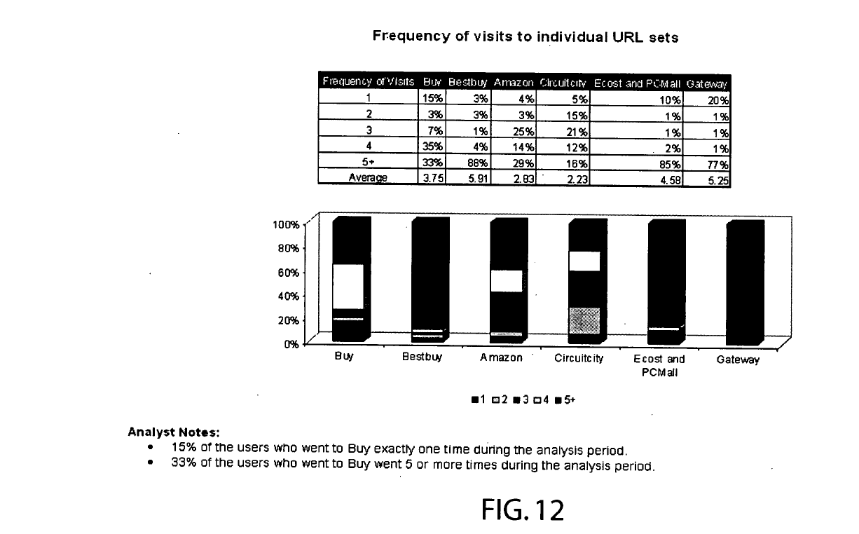

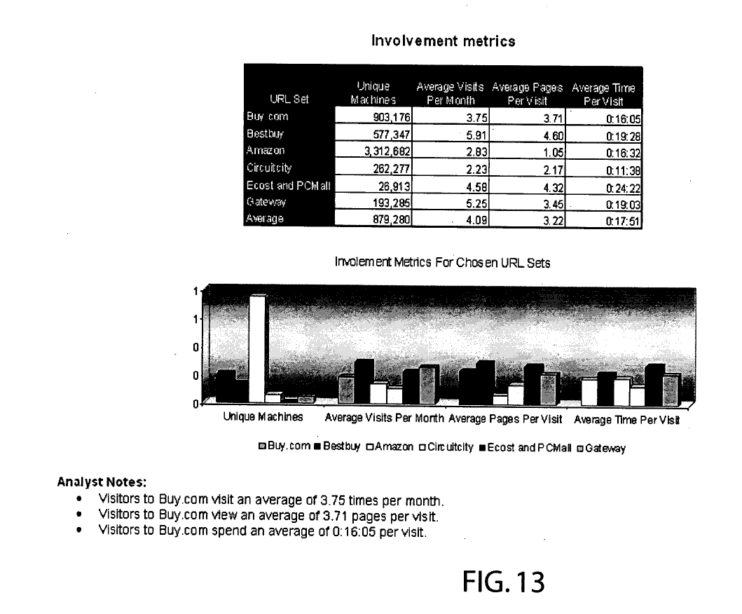

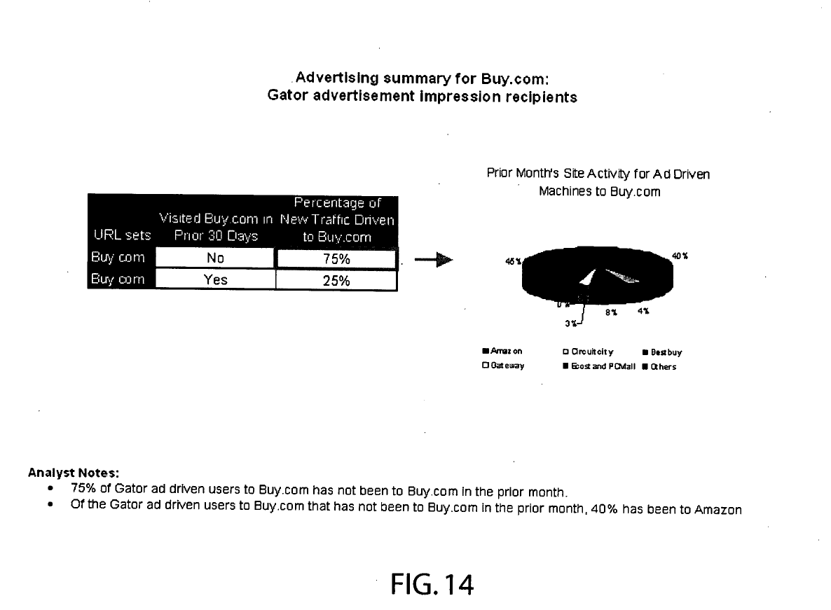

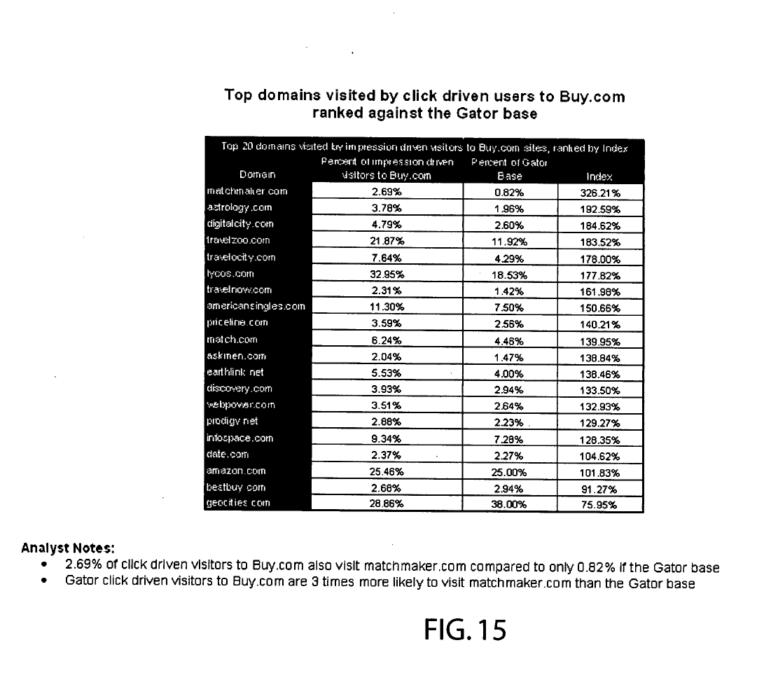

FIGS. 8-15 show example reports created by report creation module 526 in accordance with embodiments of the present invention. In FIGS. 8-15, the term “user” or “users” refers to consumers on client computers 110 (see FIG. 2). It should be noted that FIGS. 8-15 are provided herein for illustration purposes only, and that the data contained in the figures are not necessarily complete and accurate. Furthermore, references to actual businesses do not imply a relationship between the assignee of the present disclosure and those businesses. The reports of FIGS. 8-15 provide examples of the types of analysis that may be performed using the navigation data stored in datamart 508. In light of the present disclosure, those of ordinary skill in the art will appreciate that other types of reports indicative of website performance may also be generated using the teachings of the present disclosure.

FIG. 8 shows an example report of user penetration within chosen URL sets. In the example of FIG. 8, the report is for a category comprising Internet retailers, and the chosen URL sets include the URLs of buy.com, BestBuy, Amazon, Circuit City, Ecost And PCMall, and Gateway. FIG. 8 shows traffic by consumers who only went to one of the aforementioned sites in the chosen URL sets. Such consumers are also referred to as “unique users.” The “Analyst Notes” provide an English explanation of the data contained in the report. In the “Analyst Notes,” the “24%” and “Buy” were dynamically inserted by report creation procedure 526 from the first row of the table shown. The rest of the “Analyst Notes” contains static texts, which may vary depending on the report. The report of FIG. 8 also shows market penetration of websites within the chosen URL sets.

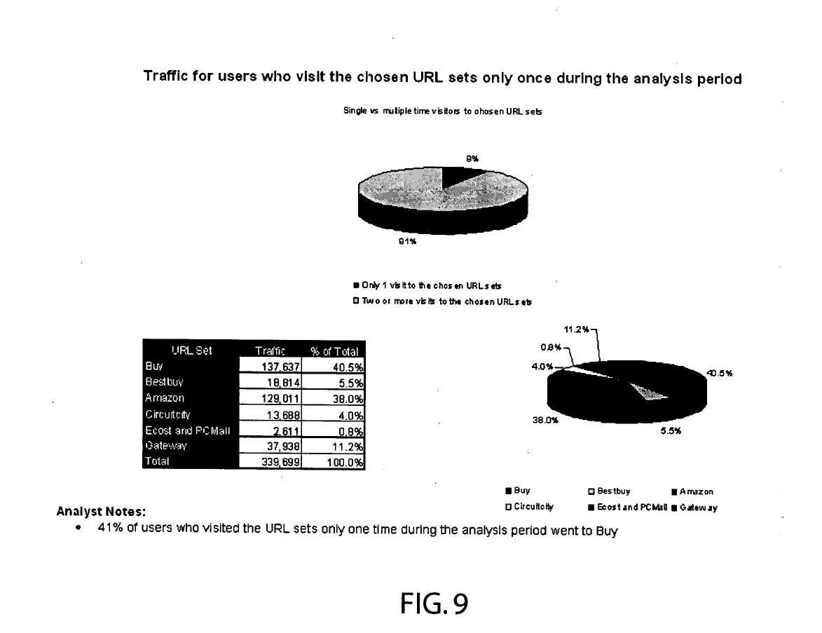

FIG. 9 shows an example report of traffic for users who visit the chosen URL sets only once during the analysis period. As in the report of FIG. 8, and other reports shown herein, the “Analyst Notes” in FIG. 9 include static and dynamically inserted text. In this particular report, “41%” and “Buy” are dynamically inserted from the accompanying table data for the retailer Buy.

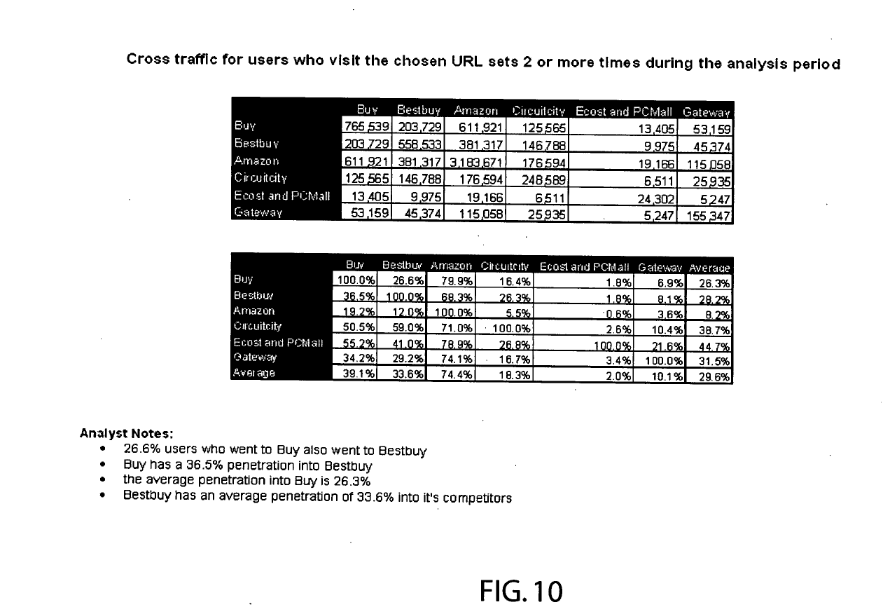

FIG. 10 shows an example cross traffic report. A cross traffic report provides comparative traffic information between two or more websites. In the example of FIG. 10, traffic to at least two websites in the chosen URL sets are compared. As a particular example indicated in the tables and Analyst Notes, 26.6% of users who went to Buy also went to Bestbuy. Cross traffic analysis, such as the one shown in the example of FIG. 10, advantageously allows a retailer or advertiser to determine the performance of a website against competitors also visited by potential or current customers.

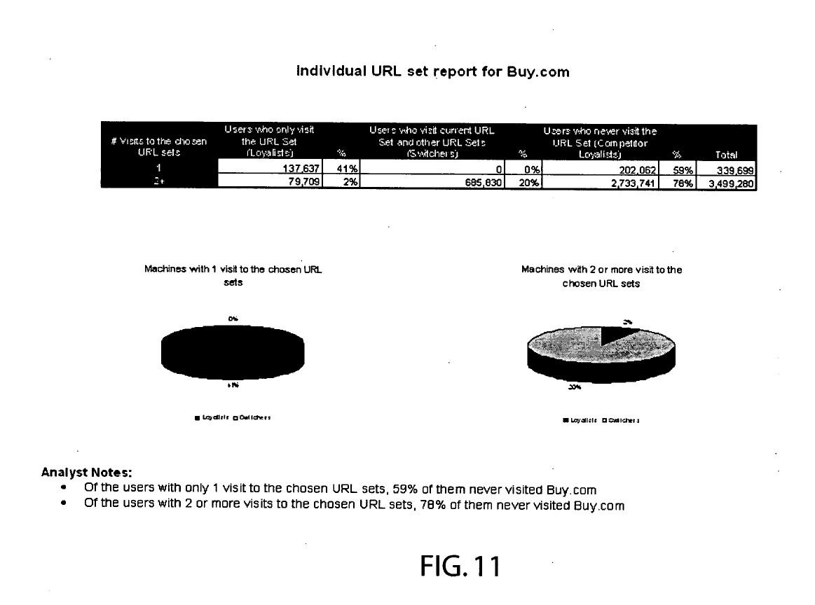

Additional example reports are shown in FIGS. 11-15.

As can be appreciated by those of ordinary skill in the art reading the present disclosure, embodiments of the present invention not only allow for analysis of website performance, but also enable a retailer or advertiser to act on the analysis by delivering advertisements to consumers via message delivery program 120 (see FIG. 2). For example, if traffic to a first website is lower than traffic to a competitor second website based on a report provided by desktop application 520 (see FIG. 5), an advertiser may contract with the provider of message delivery program 120 to deliver advertisements to consumers who visit the second website.

While specific embodiments of the present invention have been provided, it is to be understood that these embodiments are for illustration purposes and not limiting.

Many additional embodiments will be apparent to persons of ordinary skill in the art reading this disclosure.

1. A method of analyzing a performance of websites on an Internet, the method comprising:
building a first database of navigation histories of client computers on the Internet;
processing the navigation histories in the first database to generate relevant website traffic data;
storing the relevant website traffic data in a second database; and
querying the second database to generate a report indicative of website performance, the report being generated in accordance with user provided criteria.

2. The method of claim 1 wherein the navigation histories include uniform resource locators of web pages received in the client computers.

3. The method of claim 1 wherein the navigation histories include domain names of websites visited using the client computers.

4. The method of claim 1 wherein processing the navigation histories includes removing unreliable data.

5. The method of claim 4 wherein the unreliable data include navigation histories of short term consumers.

6. The method of claim 1 wherein the first database comprises a data warehouse and the second database comprises a datamart.

7. The method of claim 1 wherein the report includes traffic information of websites in a particular category of websites.

8. The method of claim 1 further comprising:
delivering advertisements to the client computers.

9. The method of claim 1 wherein the report includes website cross-traffic information.

10. The method of claim 1 wherein the report includes information about traffic to a set of uniform resource locators specified in the user provided criteria.

11. The method of claim 1 wherein the second database includes aggregated navigation data.

12. The method of claim 1 wherein processing the navigation histories in the first database includes removing navigation histories that have nonsensical data.

13. The method of claim 1 wherein the navigation histories are from client programs configured to deliver advertisements over the Internet.

14. A software tool for analyzing website traffic on an Internet, the tool comprising:
a first database configured to receive navigation histories of client computers on the Internet;
a submission module configured to receive reporting criteria from a user; and
a report creation module configured to generate a report in accordance with the reporting criteria, the report being based on the navigation histories.

15. The software tool of claim 14 further comprising a report status module configured to provide a status of a report requested by way of the submission module.

16. The software tool of claim 14 further comprising:
a second database configured to receive relevant website traffic data, the relevant website traffic data being obtained by processing the navigation histories; and
wherein the report is generated by querying the second database.

17. A method of analyzing a performance of locations on a computer network, the method comprising:
collecting navigation histories of client computers on a computer network;
processing the navigation histories to obtain relevant navigation data; and
generating a report in accordance with user provided criteria, the report being based on the relevant navigation data and indicative of a performance of a location on the computer network.

18. The method of claim 17 wherein the navigation histories include uniform resource locators of web pages received in the client computers.

19. The method of claim 17 wherein the navigation histories include domain names of websites visited using the client computer.

20. The method of claim 17 wherein the computer network includes an Internet.

21. The method of claim 17 wherein processing the navigation histories include removing data from unreliable samples.

22. The method of claim 17 wherein the data from unreliable samples include data from short term users.

23. The method of claim 17 wherein the navigation histories are stored in a data warehouse and the relevant navigation data are stored in a datamart.

24. The method of claim 17 wherein the report includes traffic information of websites in a particular category of websites.

25. The method of claim 17 wherein the report includes website cross traffic information.
